(19) United States
(12) Patent Application Publication
(10) Pub. No.: US 2014/0048531 A1
(43) Pub. Date: Feb. 20, 2014

(54) COOKING UTENSIL WITH COMPARTMENTS

(71) Applicant: George R. Carthane, JR., Woodland Hills, CA (US)

(72) Inventor: George R. Carthane, JR., Woodland Hills, CA (US)

(21) Appl. No.: 13/586,799

(22) Filed: Aug. 15, 2012

(51) Int. Cl. H05B 6/80

(52) U.S. Cl. 219/725

(57) ABSTRACT

A cooking utensil is made of low thermal expansion glass such as Pyrex. The utensil has a bottom bowl, a top lid and a cooking plate. The bottom bowl has partitions defining cooking spaces and a central collection compartment, all of which are integral to the bowl and are made of the same material. A cooking plate rests on the top surfaces of the partitions and has a central through-hole. Food is placed on the plate. A lid covers the bowl and the plate. As the food is cooked, fats drip down through the central hole into the collection compartment. The cooking spaces may also contain food for cooking.

### FIELD OF THE DISCLOSURE

This disclosure relates to cooking utensils and, more particularly, to a cooking utensil that may be used in a common kitchen microwave oven. More particularly, the cooking utensil includes a bottom bowl having compartments integral with the bottom bowl and made of a transparent material suitable for use in a household microwave oven. A cooking plate rests on the walls of the compartments and allows fluids to drain into a compartment within the bottom bowl.

### BACKGROUND OF THE DISCLOSURE

A cooking utensil of the present novel design has several advantages over other devices for preparing food, especially in microwave ovens. It fits in with a fast paced lifestyle or for a family in which the persons having cooking responsibilities have little time or energy for the task. It speeds preparation and reduces energy usage. For example, compare warming three individual dishes at four minutes each (twelve minutes of microwave time) verses three items warmed together for six minutes of microwave time. With the disclosed device, there are savings in time, the number of dishes used in preparation, the number of dishes that need to be cleaned, electricity and gas usage, hot water and wear and tear on the dishwasher and microwave.

The junctions between surfaces within the utensil are smooth and curved with concave radii that facilitate removing food with a spoon or spatula as well as cleaning.

The utensil is made of a low thermal expansion glass making it useable in a conventional oven as well as a microwave oven. Being transparent, it is easy to view the food within to monitor its progress. Glass is also preferred because it does not add unwanted chemistry to the food. Because it is made of glass, the bottom bowl can be cast in one piece simplifying the manufacturing process.

The utensil also includes a cooking plate housed entirely within the utensil. Food may be placed on the plate as well as in the compartments below. Foods that produce fat runoff can be cooked on the plate, which is configured to direct the juices to a central opening in the plate and then into a collection compartment below the central opening. The juices can then be discarded or used in preparing gravies and sauces.

The utensil includes a lid, which when closed entraps moisture within the utensil to promote the cooking process.

The fast-paced lifestyle for many people has catapulted processed foods and fast food to become an integral component for daily nutrition. It is the intent of this novel utensil to assist people and speed up cooking time, with the ability to cook several items at once in a novel way. It is also the intent to assist people in preparing healthier versions of fast food quickly at home. It is also possible to realize a monetary annual saving by reducing home utility cost and eating out less.

### SUMMARY OF THE INVENTION

It is an object of this invention to provide a cooking utensil having a bowl and internal compartments that are defined by walls, the walls being integral with the bowl.

It is a further object of this invention to provide a cooking plate within the bowl, the cooking plate configured to direct juices into a centrally located collection chamber, the collection chamber having a cylindrical shape.

Another object of this invention is to provide junctions between the walls within the bottom bowl, the junctions being curved with a concave radius so as to facilitate removal of food within the compartments and to facilitate cleaning.

Yet another object of the invention is to provide the cooking plate with knobs and/or finger holes to facilitate the insertion and removal of the cooking plate from the bottom bowl of the utensil.

These and other objects are preferably accomplished by providing a cooking utensil as described below.

### BRIEF DESCRIPTION OF THE DRAWINGS

FIG. 1 is a perspective view of a cooking utensil showing the exterior walls as being transparent in order to show the interior construction in accordance with the teachings of the invention;

FIG. 2 is another perspective view of a cooking utensil similar to FIG. 1 showing the exterior walls as being transparent, with the lid raised;

FIG. 3 is another perspective view of a cooking utensil showing the exterior walls as being transparent, with more detail shown in the cooking plate and the configuration of the walls defining the compartments;

FIG. 4 is a side view of the cooking utensil of FIG. 1 showing the exterior walls as being transparent;

FIG. 5 is a side view of an alternative shape of the bottom bowl of the cooking utensil;

FIGS. 6A and 6B are cross-sectional views taken along the plane 6 in FIG. 1, wherein FIG. 6A shows a relatively small radius of curvature at numeral 21A and FIG. 6B shows a larger radius of curvature at numeral 21 B to demonstrate that the concave radius of curvature at the junctions of the walls of the compartments with the bottom bowl may be varied in keeping with the spirit of the disclosure;

FIG. 7 is a detailed view of portion 7 depicted in FIG. 9 showing a detailed view of the construction of the lip on the bottom bowl 5 and the mating features with the lid 7;

FIG. 8 is a top view of one embodiment of bottom bowl 5 showing four compartments including a central cylindrical chamber; and,

FIG. 9 is a cross sectional view taken along plane 9 in FIG. 1.

### DESCRIPTION OF THE PREFERRED EMBODIMENTS

The drawings show a microwaveable kitchen utensil 1 having a plurality of compartments 3. In the preferred embodiment, all components of the utensil are made of an inert microwaveable material such as low-thermal-expansion borosilicate glass or soda-lime glass such as that marketed under the Pyrex brand, although other materials may be used. A glass material is preferred because it is generally inert when used as cookware. Thus, it will not introduce unwanted chemicals into the food, nor will it react with and change the composition of the food during cooking and afterwards.

The utensil 1 includes a bottom bowl 5, a top lid 7 and a cooking plate 9. The bottom bowl 5 is open at the top and has external surfaces that may include curved portions 11 and/or straight portions 13. The bottom bowl 5 may have various shapes, one of which is shown in FIG. 5 where the bottom bowl is semispherical 15 with a flat outside bottom surface 17 so that it will rest steadily on a counter top. The bottom bowl 5 could also have a generally rectangular, oval, elliptical or other shape, so long as it has an external bottom surface that is essentially flat for resting on a counter. However, the dimensions should be such that the utensil 1 can rest comfortably on the turntable of a household microwave oven.

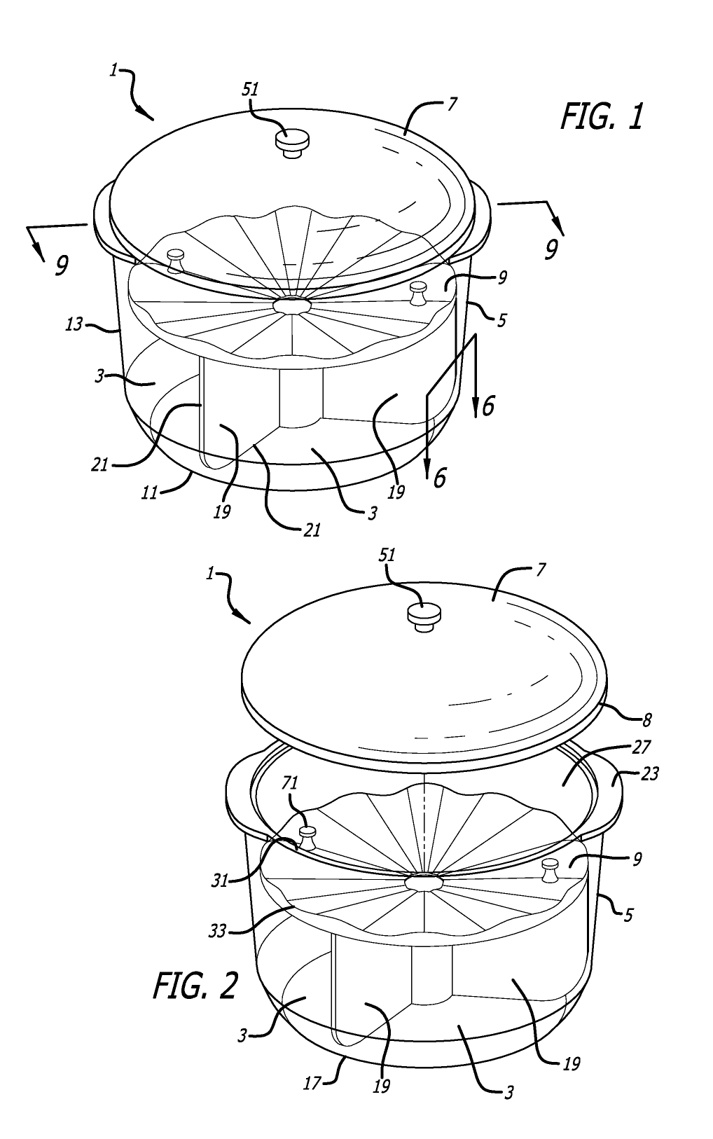

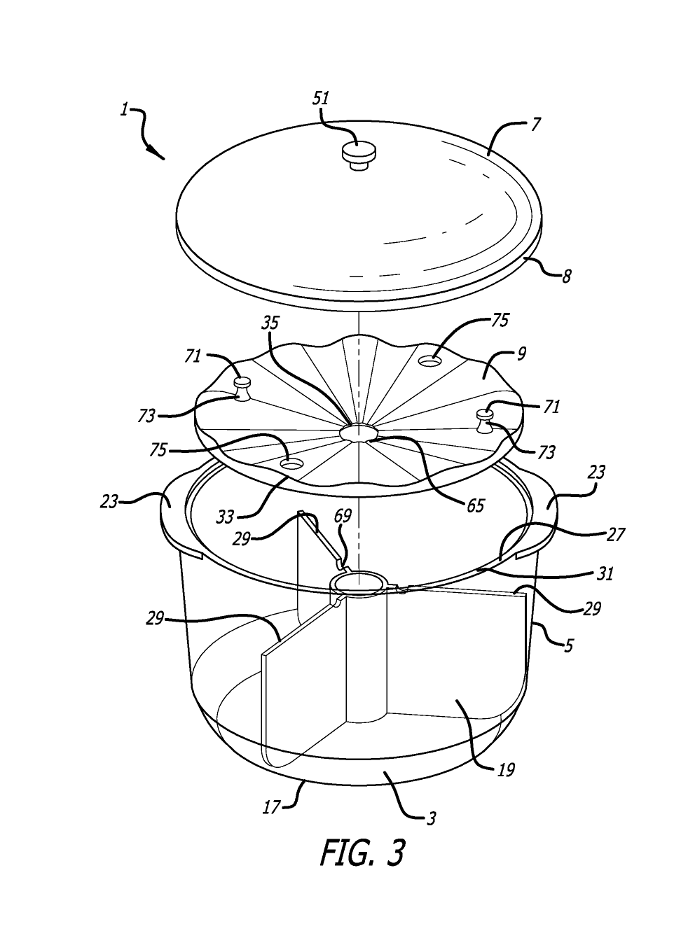

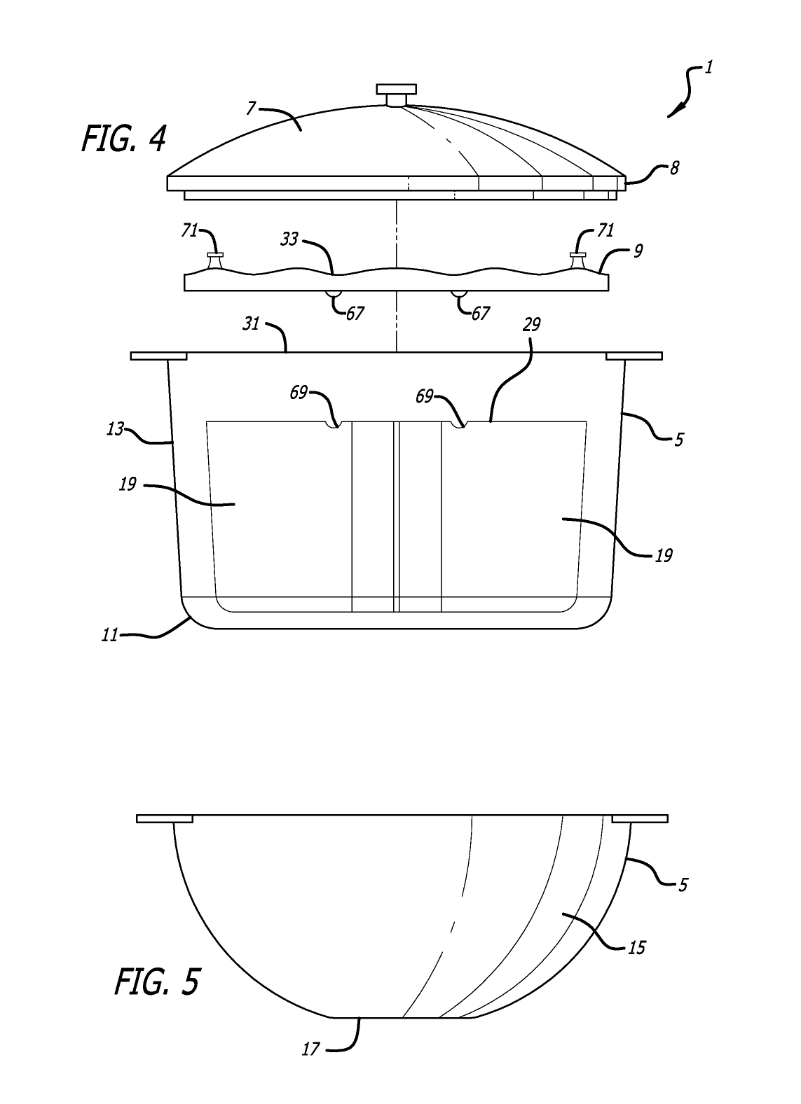

The interior surface 10 of the bottom bowl 5 has contours shaped generally the same as the contours of corresponding exterior surfaces of the bottom bowl 5. Inside the bowl 5 are a plurality of internal compartments 3 that are defined by walls 19 that are integral with the interior surface 10 of the bottom bowl 5. The number of compartments 3 is variable, but a minimum of three is contemplated in order to provide a stable resting surface for a cooking plate, discussed below. FIGS. 1-4 depict the preferred embodiment of three compartments 3.

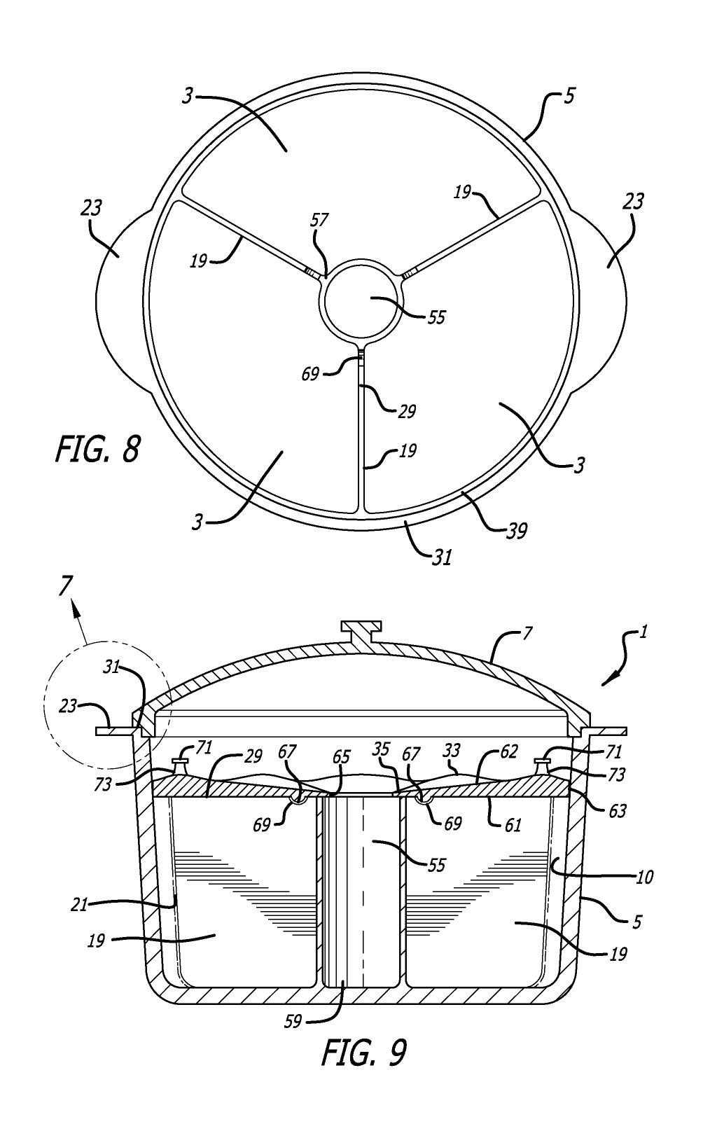

The junctions 21 of the walls 19 and the interior of the bottom bowl 5 are curved (See FIG. 6) to blend the junctions of the wall portions with the interior bowl surface to facilitate the removal of substances that are placed into one or more of the compartments and/or to facilitate the cleaning of the junctions 21. A cylindrical chamber 55 is located in the central area of bowl 5 and is depicted in a top view in FIG. 8. The walls 19 are joined to cylindrical chamber 55 by connections 57. The chamber 55 is open at the top, but the cylindrical chamber bottom 59 is formed integral with the interior surface of the bottom bowl 5. In the preferred embodiment, all of the intersections within the bottom bowl 5 are curved to facilitate manufacturing and cleaning, including the connections 57 and the intersection of the cylindrical chamber bottom 59 with the interior surface of the bottom bowl 5. The curved portions are generally concave and may have radii that are substantially greater than depicted in the drawings of the preferred embodiment disclosed herein. Exemplary radii may range from approximately 0.0625 in up to approximately 2 in. As is described below, cylindrical chamber 55 will collect the majority of liquids draining from cooking plate 9, so as not to contact other foods cooking in compartments 3 located below the cooking plate 9. Liquids accumulated in chamber 55 may be removed with a baster, which is commonly defined as a tube with a rubber bulb used to take up and release melted fat or gravy. Certainly, the bowl 5 can be inverted to empty chamber 55. Chamber 55 can also be used to infuse essences of spices into the food in compartments 3 or foods on cooking plate 9 without including the actual spice in the finished food.

The bottom bowl 5 has lifting grips 23 at the periphery of the top opening 27. The top surfaces 29 of the walls 19 defining the compartments are located below the periphery of the bowl lip 31 as measured from the external bottom surface 17 when the bowl is resting on a counter top.

A cooking plate 9 is positioned within the bottom bowl 5 on the top surfaces 29 of the walls 19. The cooking plate 9 has a flat underside 61 that rests on the top surfaces 29 and a drainage contour on its upper surface, which is depicted in the drawings as wave contour 33. The drainage contour can have other configurations besides waves, such as ribs, or the drainage contour could be flat and sloping from the outside edge to the central portion. The drainage contour may include raised surfaces of various configurations adapted to facilitating the flow of liquids toward the central opening 35. FIG. 9 includes a cross sectional view of a portion of cooking plate 9 and shows a plate upper surface 62 gently sloped downwardly from the outer periphery 63 to a central opening 35 passing through the entire thickness of the plate 9. The wave contours 33 and the slope of the plate 9 urge liquids on the plate 9 produced during cooking toward the central opening 35 where the liquids drain into cylindrical chamber 55. The distance between the top surface of plate 9 and the bowl lip 31 should be large enough to accommodate food placed on the plate for cooking, and can be designed accordingly.

Cooking plate 9 has, near the central opening 35, a thickened rim 67 projecting downwardly as shown in FIG. 9. The rim 67 extends around the full circumference of the central opening 35 and seats in a niche 69 located in the top surface 29 of wall 19. The niche 69 and rim 67 have compatible shapes allowing the surfaces of the two elements to mate in a loose fit. In the preferred embodiment, the depth of the niche 69 is only a few millimeters, in the general range of three to five millimeters, but the size and mating tolerances may be altered by persons ordinarily skilled in the art to allow the cooking plate underside 61 to sit on top surfaces 29 without bridging. The diameter of plate 9 central opening 35 is slightly smaller than the inner diameter of chamber 55 resulting in an overhang of plate inner edge 65 relative to the inner diameter of central opening 35, facilitating the collection of liquids in chamber 55. Rim 67 also serves to reinforce central opening 35 and adds integrity to plate 9 especially when the weight of food is added to the top surface 62.

The outside diameter of plate 9, out to plate outer periphery 63, is sized to fit inside bottom bowl 5 in a loose fit to allow for easy insertion and removal. In the preferred embodiment, the OD of plate 9 is approximately two to five mm smaller than the corresponding ID of bottom bowl 5. Plate 9 has two lifting knobs 71 positioned at strength and balance points to allow easy placement and removal of plate 9. In the preferred embodiment, the lifting knobs 71 are positioned at approximately twenty percent of the distance between the plate outer periphery 63 and the plate inner edge 65 as calculated from the outer periphery 63. Lifting knobs 71 have flared stems 73 that are flared outwardly from their central axes, the thickness of the flares increasing from the top of the stems 73 to the point of attachment of the stems 73 to plate 9. The knobs 71 and stems 73 are formed integral to the cooking plate 9, and are preferably made of the same material as the plate 9. This flared attachment spreads the shear and tension loads when a weighted plate 9 is being lifted.

As an alternative to lifting knobs 71, finger holes 75 may be formed into plate 9 at approximately the same locations as the knobs 71 for lifting the plate 9. See FIG. 10. The contours of plate upper surface 62 may be adjusted to minimize flow of liquids into the compartments 3 below through the finger holes. However, a small flow of liquid into the compartments is not considered seriously detrimental to the functionality of the cooking utensil. Also, a raised curb may be placed around each finger hole to prevent liquids from entering compartments 3. Some cooling and venting of steam from compartments 3 would be necessary for approximately one minute or more before inserting fingers into the finger holes.

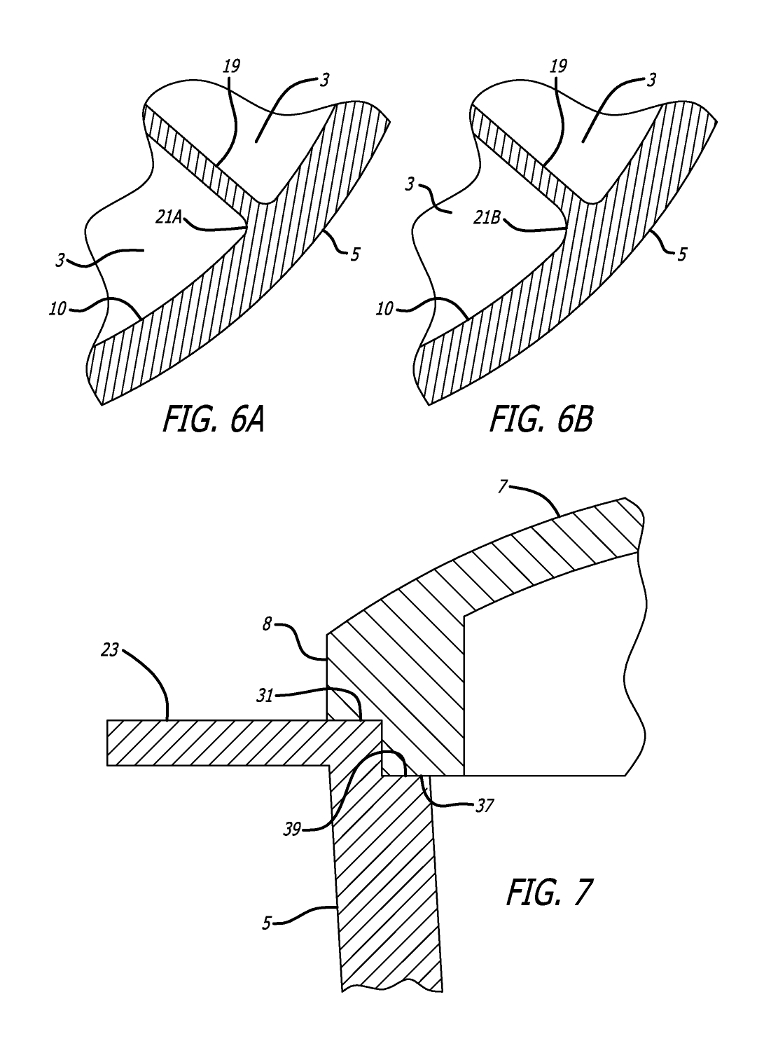

The top lid 7 has a top lid lip 8 that mates with the bowl lip 31 in any standard way. In the preferred embodiment, the top lid lip 8 includes a protrusion 37 that mates with indention 39 on the bowl lip 31. See FIG. 7. Both protrusion 37 and indention 39 extend around the entire circumference of the top lid 7 and the bottom bowl 5, respectively. This structure provides for a close fit between the tip lid 7 and bottom bowl 5, thereby holding in heat and moisture within the cooking volume inside the microwaveable kitchen utensil 1. Even though the drawings depict relatively sharp corners, a person of ordinary skill in the art will understand that the corners can be somewhat rounded.

The top lid 7 may have a knob 51 on its top surface to allow it to be easily lifted.

It should be understood that although the drawings of the preferred embodiment show three compartments 3, a different number may be used while adhering to the inventive concepts claimed herein.

In use, food may be placed into the compartments 3 for cooking in a microwave oven. Food may also be placed on the cooking plate 9, whether food is also placed into the compartments or not. Water may be placed in one or more compartments 3 to generate moisture during cooking. Food may be placed on the cooking plate and the compartments may be left empty to collect juices such as fat that is released during cooking.

While the above description contains many specifics, these should not be construed as limitations on the scope of the disclosure, but rather as an exemplification of the embodiments therein. It is to be understood that the invention is not limited to these specific embodiments. Accordingly, the invention is not limited to the precise embodiments described in detail hereinabove. With respect to the claims, it is applicant's intention that the claims not be interpreted in accordance with the sixth paragraph of 35 U.S.C. §112 unless the term “means” is used followed by a functional statement. Further, with respect to the claims, it should be understood that any of the claims described below may be combined for the purposes of the invention.

What is claimed is:

1. A cooking utensil suitable for use in a home kitchen type microwave oven comprising:
a bottom bowl having a bottom portion, a side portion, an opening at the top and a lip at the opening;
walls inside the bottom bowl defining a plurality of compartments;
said walls formed integrally with the bottom bowl;
said compartments open at the top;
a cooking plate positioned at the top of said compartments, said cooking plate adapted to supporting food;
said cooking plate having a drainage opening through which liquids resulting from food being cooked on the cooking plate may drain downwardly;
at least one of the compartments configured to collect the liquids; and,
said liquid collecting compartment positioned below the drainage opening in the cooking plate.

2. The cooking utensil of claim 1 wherein the liquid collecting compartment and the drainage opening are centrally located.

3. The cooking utensil of claim 2 wherein the liquid collecting compartment has a cylindrical shape.

4. The cooking utensil of claim 1 wherein the bottom bowl has an interior surface and the junctions of the walls with the interior surface present concave surfaces whereby retrieval of substances within the compartments is facilitated.

5. The cooking plate of claim 1 wherein at least a portion the upper surface of the cooking plate as viewed when the cooking plate is positioned at the top of the compartments is sloped downwardly from its outside diameter toward the drainage hole.

6. The cooking plate of claim 5 wherein the upper surface includes a drainage contour.

7. The cooking plate of claim 5 wherein the drainage contour includes raised portions.

8. The cooking plate of claim 6 wherein the drainage contour includes a wave shape.

9. The cooking plate of claim 5 wherein the drainage contour includes ribs.

10. The cooking plate of claim 5 wherein the drainage contour includes a flat surface.

11. The cooking utensil of claim 1 wherein the top surfaces of the walls are located below the lip of the bottom bowl.

12. The cooking utensil of claim 11 wherein the cooking plate rests on the top surfaces of the walls.

13. The cooking utensil of claim 1 wherein the cooking plate includes at least one lifting knob.

14. The cooking utensil of claim 1 wherein the cooking plate includes at least one finger lifting hole.

15. The cooking utensil of claim 4 wherein at least one of the concave surfaces has a radius of between xxx to xxx.

16. The cooking utensil of claim 13 wherein the lifting knob is flared outwardly at its junction with the cooking plate.

17. A cooking utensil suitable for use in a home kitchen type microwave oven comprising:
a bottom bowl having a bottom portion, a side portion, an opening at the top and a lip at the opening;
walls inside the bottom bowl defining a plurality of compartments;
said walls formed integrally with the bottom bowl;
said compartments open at the top;
a cooking plate positioned at the top of said compartments, said cooking plate adapted to supporting food;
said cooking plate having a drainage opening through which liquids resulting from food being cooked on the cooking plate may drain downwardly;
a liquid collecting compartment positioned below the drainage opening in the cooking plate;
the liquid collecting compartment and the drainage opening are centrally located;
the liquid collecting compartment has a cylindrical shape;
the bottom bowl has an interior surface and the junctions of the walls with the interior surface present concave surfaces whereby retrieval of substances within the compartments is facilitated;
at least a portion the upper surface of the cooking plate as viewed when the cooking plate is positioned at the top of the compartments is sloped downwardly from its outside diameter toward the drainage hole;
the upper surface includes a drainage contour, at least a portion of which has a raised surface;
the top surfaces of the walls are located below the lip of the bottom bowl;
the cooking plate rests on the top surfaces of the walls; and,
the cooking plate includes at least one lifting knob.
